(19) United States
(12) Patent Application Publication
(10) Pub. No.: US 2012/0253880 A1
(43) Pub. Date: Oct. 4, 2012

(54) SIMULATING DEPENDENCY OF TOKEN ARRIVAL ON PROCESS PERFORMANCE

(75) Inventors: Manish Kumar, Bangalore (IN); Jyoti Manjeshwar Bhat, Bangalore (IN)

(73) Assignee: Infosys Limited, Bangalore (IN)

(21) Appl. No.: 13/195,792

(22) Filed: Aug. 1, 2011

(30) Foreign Application Priority Data
Mar. 31, 2011 (IN) 1049/CHE/2011

(51) Int. Cl. G06Q 10/00

(52) U.S. Cl. 705/7.27

(57) ABSTRACT

A process analysis tool simulates the dependency of token arrival on performance of a business process. For example, the process analysis tool includes a token generator and a feedback module. The token generator schedules arrival of tokens to a business process simulator and, using feedback that depends on state of a process model, adjusts a parameter that characterizes the arrival of tokens. In particular, the adjustment can simulate the adverse effects of customer perception of processing cycle time and/or queue length on the arrival of tokens. The feedback module generates the feedback for the token generator. In this way, the process analysis tool simulates how the arrival of tokens depends on performance of the process model. A business analyst, other user or automated testing tool can use the process analysis tool to gain a better understanding of resource requirements or lost opportunities for a business process.

### BACKGROUND

A business process is a collection of activities, operations or services, which are performed in order to accomplish a goal. A business process may be decomposed into an ordered sequence of sub-processes representing activities, operations or services (generally, “sub-processes”), each sub-process having attributes and contributing in some way to the achievement of the overall goal of the business process. Typically, a sub-process consumes resources and takes time to complete. When resources are not available for the sub-process, if a new job or new work arrives for the sub-process, the new job/work waits for processing until resources are available. Also, a given sub-process may be dependent on the completion of one or more other sub-processes before the given sub-process can begin. This may result in a new job or new work waiting for processing by the given sub-process.

Business process modeling and simulation help analysts understand the dependencies and inter-relationships between different parts of a business process, understand timing requirements, and understand resource requirements. Different business process management tools model business process flow in different ways. For example, some tools define a process model using a Petri net (place/transition net) or other mathematical modeling language to describe the business process as a distributed system of sub-processes. Other tools define a process model using business process modeling notation, a process map or another graphical representation to specify sub-processes of the business process in the model. Still other tools use an event-driven process chain or other approach to define a process model.

Some business process management tools also provide simulation capabilities. Business process simulation is used to analyze a process model to predict, forecast or verify the behavior of the process model (and underlying business process represented by the model) for a given set of inputs. In particular, business process simulation is often used to analyze performance in terms of a metric like throughput, processing cycle time per job, cost or resource utilization. Before recommending a new process design, an analyst can evaluate a process model for the new process design, which may help the analyst improve the new process design or better understand the tradeoffs in design decisions. The simulation can use historical data or other data as inputs for analysis of the process model. In business process simulation, a work order or job can be represented with a token. The scheduling of tokens that arrive for processing by a process model is one aspect of simulation. Conventionally, token arrival (also called instantiation) is modeled using a statistical model meant to capture the rate and variability in token arrival.

### SUMMARY

In summary, the detailed description presents techniques and tools for improving business process analysis by simulating the dependency of token arrival on process performance. In some scenarios, this leads to a better understanding of the resource requirements for a business process or helps identify lost opportunities due to failure to timely process new work/job orders.

According to a first aspect of the techniques and tools described herein, a process analysis tool includes a token generator and a feedback module. The token generator is operable to schedule arrival of tokens to a business process simulator. The token generator is also operable, using feedback that depends on state of a process model, to adjust a parameter that characterizes the arrival of tokens. The feedback module is operable to generate the feedback for the token generator. In this way, the process analysis tool simulates the dependency of the arrival of tokens on performance of the process model.

The process analysis tool can also include other modules. For example, the process analysis tool can include the business process simulator itself, which executes the process model, and which can include a performance capture module that is operable to measure the state of the process model. The process analysis tool can also include an impact analyzer that is operable to determine a number of tokens lost, in aggregate during a time interval, due to the performance of the process model. The process analysis tool can include a setting adjustment module that is operable to accept input regarding settings, an input module that is operable to accept input regarding the process model or the arrival of tokens, and/or an output module that is operable to present visual indicators of effects of the feedback on the arrival of tokens or the number of tokens processed.

According to another aspect of the techniques and tools described herein, a business analyst, other user or automated testing tool (generally, “analyst”) uses a process analysis tool that simulates the dependency of the arrival of tokens on performance of a process model. The process analysis tool includes a token generator that is operable to schedule arrival of tokens to a business process simulator. The analyst provides input to parameterize the arrival of tokens to the business process simulator and provides input to specify a process model. The analyst can further provide input that specifies settings (e.g., feedback function settings) of the process analysis tool. The analyst initiates analysis of the process model by the process analysis tool and, responsive to results from the process analysis tool, can assess intermediate and/or final results of the analysis.

Conversely, according to another aspect of the techniques and tools described herein, a process analysis tool reacts to input from an analyst. The process analysis tool receives input to parameterize the arrival of tokens to the business process simulator, and parameterizes token arrival accordingly. The process analysis tool also receives input to specify a process model, and sets the process model accordingly. The process analysis tool can further receive input that specifies settings of the process analysis tool. The process analysis tool initiates analysis of the process model for the parameterized arrival of tokens, which is subject to adjustment using feedback that depends on state of the process model. The process analysis tool can provide intermediate and/or final results of the analysis to the analyst.

According to another aspect of the techniques and tools described herein, a token generator or other module of a process analysis tool schedules arrival of tokens to a business process simulator. One or more parameters characterize the arrival of tokens. For example, the parameter(s) include a rate for a probability distribution. The token generator or other module receives feedback that depends on state of a process model in the business process simulator. Then, based at least in part on the feedback, the token generator or other module adjusts at least one of the one or more parameters that characterize the arrival of tokens to simulate dependency on performance of the process model. For example, such adjustment can simulate the effects of customer perception of processing cycle time and queue length on the arrival of tokens. The process analysis tool can accept input regarding settings (e.g., an output format setting, feedback function settings), then adjust one or more of the settings according to the input. In some implementations, the process analysis tool determines an aggregate number of tokens lost during a time interval due to the performance of the process model. The process analysis tool can then present visual indicators of effects of the feedback on the arrival of tokens and/or the number of tokens processed.

Conversely, according to another aspect of the techniques and tools described herein, a process analysis tool performs business process simulation. A business process simulator or other module of the process analysis tool measures the state of a process model, which can include a number of tokens waiting for one or more activity centers and/or a representative processing cycle time. The state information is provided to a token generator, feedback module or other module of the process analysis tool, which generates feedback from the measured state of the process model.

The foregoing and other objects, features, and advantages of the invention will become more apparent from the following detailed description, which proceeds with reference to the accompanying figures.

### BRIEF DESCRIPTION OF THE DRAWINGS

FIG. 1 is a diagram of a generalized token generator and generalized process model with activity centers and queues of tokens.

FIG. 2 is a diagram of an example process analysis tool in which the dependency of token arrival on process performance is simulated.

FIGS. 3 and 4 are flowcharts showing different aspects of a generalized technique for using a process analysis tool that simulates dependency of token arrival on process performance.

FIG. 5 is a flowchart showing a generalized technique for adjusting token arrival based at least in part on feedback that depends on state of a process model.

FIG. 6 is a flowchart showing a generalized technique for measuring and providing state of a process model for feedback to token arrival scheduling.

FIG. 7 is a block diagram of an example computing system in which some of the techniques and tools described herein can be implemented.

### DETAILED DESCRIPTION

The detailed description presents techniques and tools for improving business process analysis by simulating the dependency of token arrival on process performance. Using such process analysis can lead to a better understanding of the resource requirements for a business process. It can also help identify work/job orders that are lost due to perception of slow processing or long waits for processing.

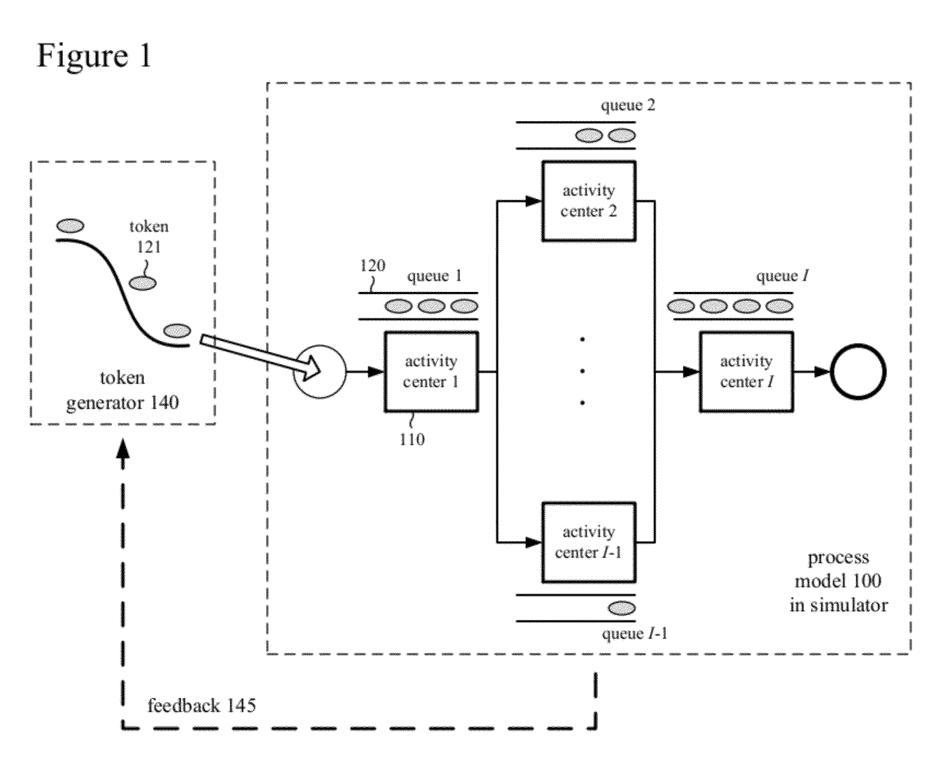

FIG. 1 illustrates a generalized token generator (140) and generalized process model (100) in a business process simulator. The process model (100) can be any representation of a business process. The process model (100) includes one or more activity centers (110), which are shown as activity center 1 to activity center I. An activity center (110) can be any representation of a sub-process, node or other part of the business process. A token (121) represents work or a job to be performed by an activity center (110). The following table gives examples of operations, activities or services that can be represented by a process model, activity centers, and tokens.

TABLE 1
Examples of Operations, Activities or Services Represented
by a Process Model, Activity Centers and Tokens.

| Process Model | Activity Centers | |
|---|---|---|
| Represents: | Represent: | Tokens Represent: |
| retail store | checkout counters at the | customers waiting for |
| | store | a checkout counter |
| bank | automatic teller machines | users waiting for an |
| | (ATMs) | ATM |
| document processing | stages of the document | documents to be pro- |
| service | processing service | cessed |
| online transaction | stages of the transaction | transactions |
| processing service | processing service | |
| call center | service representatives | callers |

When a process model includes multiple activity centers, different activity centers can operate in parallel, in a series, or according to a more complicated process flow. In FIG. 1, the activity centers (110) of the process model (100) are generally organized in three stages in a series. In the first stage, activity center 1 processes tokens that, upon completion of processing by activity center 1, are distributed to an activity center of the second stage. The second stage includes activity center 2 to activity center I−1, which operate in parallel. Each activity center in the second stage processes tokens that, upon completion of processing, are distributed to activity center I of the third stage. For example, the process model (100) shown in FIG. 1 can represent a fast food restaurant, where activity center 1 represents an order counter at which all customers place their orders, activity centers 2 to I−1 represent checkout counters at which customers pick up their orders and pay, and activity center I represents a single self-service beverage counter at which all customers get beverages. Alternatively, the process model includes more or fewer stages of activity centers. For example, the process model can include a single stage with multiple activity centers 1 to I operating in parallel.

In general, the process model includes one or more stages, and each stage can include one or more activity centers. Different activity centers can represent multiple instances of same sub-process in a single stage of the business process. For example, in FIG. 1, activity centers 2 to I−1 operate in parallel and represent multiple instances of the same sub-process. Or, different activity centers can represent different sub-processes in different stages of the business process. For example, in FIG. 1, activity centers 1, 2 and I represent different sub-processes in a series for the process model (100). Depending on the process model, one or more stages may be skipped for a given token. In FIG. 1, after the activity center(s) (110) of a given stage, all tokens are distributed to a single next stage or end of the process model (100). In a more complicated process flow, depending on the outcome of processing at the activity center(s) of a given stage, tokens can be distributed to any of multiple next stages in the alternative. The flow of processing can be unidirectional (as shown in FIG. 1), or the process model can include loops. A given token can represent the same work order/job through all stages of the process model (e.g., represent a particular customer as that customer moves to different counters), or a set of one or more related tokens can represent different features or constituent parts of a work order/job in different stages of the process model (e.g., represent different parts of a complicated transaction or document).

In FIG. 1, each activity center (110) has a queue (120) of zero or more tokens (121) that await processing by that activity center (110). Queue 1 is associated with activity center 1, queue 2 is associated with activity center 2, and so on. Alternatively, one or more of the activity centers can share a queue. For example, the activity centers 2 to I−1 can share a single queue for the second stage. The allowed queue size can vary from stage-to-stage or activity center-to-center. During simulation, queues (120) can have different lengths of tokens waiting at different activity centers (110) due to processing delays.

In FIG. 1, a new token (121) is enqueued in queue 1 for activity center 1. After activity center 1, a token (121) is enqueued in one of the queues for activity centers 2 to I−1. In general, at a given stage of the processing in the process model (100), a new token is put in the appropriate queue (120) with the shortest length or otherwise enqueued according to one or more rules of the process model (100) (e.g., considering category or classification of the work/job represented by the respective tokens).

In any case, tokens (121) arrive for processing by the process model (100) according to scheduling set by the token generator (140). The token generator (140) simulates the rate (e.g., one new token on average every 5 seconds) and pattern (e.g., regularly spaced intervals between new tokens versus irregular bursts of new tokens) of new work or job orders for the business process. In terms of the examples shown in Table 1, the token arrival scheduling can model the arrival of customers at checkout counters of a retail store, users at ATMs, documents for processing by a document processing service, new transactions, or new callers to a call center.

Many business process simulation tools treat token arrival as being independent of process performance. In such tools, an analyst sets parameters that define token arrival. The parameters that define token arrival may be variables, but they are independent of process performance. Based on the parameters, token arrival is scheduled for the process model. Tokens are generated independent of process outcomes, and tokens are placed into the input queue (or queues) of the process model being simulated. The business process simulation processes each and every token which arrives as input, passing the respective tokens to the activity centers of the process model being simulated.

Business process simulation in which process performance does not affect token arrival is unrealistic for some scenarios. In particular, if a business process becomes slow or lags behind the rate at which new tokens arrive, such process performance may adversely affect token arrival. For example, if checkout counters at a grocery store are especially slow in processing customers, or lines at the checkout counters are very long, customers may simply decide to leave the store and shop elsewhere. As detailed below, there are many other scenarios in which customer behavior changes depending on business process performance.

Various factors can adversely affect token arrival in ways that correspond to customer perception of process performance. For example, token arrival may depend on a performance indicator such as visible queue length of tokens representing customers, users, documents, transactions, or callers (generally, “customers”) ahead in line. As another example, token arrival may depend on a performance indicator such as the perceived typical cycle time for processing a work order. Other performance indicators may also negatively affect token arrival.

If token arrival is not adjusted depending on process performance, business process simulation can become inaccurate in several respects. For example, process simulation may show a build up of tokens in queues due to slow processing cycle time. This might lead to an analyst to conclude simply that resources are over-utilized or that more resources are required to satisfy demand. With more realistic simulation, token arrival rate would slow down due to customer perception of slow processing cycle time, and tokens would not build up in queues, so the analyst can make more informed decisions. As another example, process simulation may show that all tokens are processed eventually, despite long queues of tokens that await processing at some times. This may present a misleading view of the business process by failing to account for tokens that in reality do not arrive due to the perception of long wait time. With more realistic simulation, the analyst may gain insights about the number of tokens which do not arrive due to negative feedback. In this way, the analyst can learn about lost opportunities in terms of lost customers and corresponding loss of revenue.

According to techniques and tools described herein, a process analysis tool adjusts the scheduling of token arrival based on process performance. The parameters that define token arrival are dependent variables that depend on the process performance. In many scenarios, this provides more accurate and realistic simulation results by simulating the dependency of the arrival of new work orders on the performance of a business process. More accurate scheduling of token arrival in turn supports better analysis of overall process performance, better resource allocation, and better operational decision-making.

In FIG. 1, the token generator (140) receives feedback (145) that depends on the state of the process model (100). For example, the feedback (145) relates to visible queue lengths for the queues (120) and processing cycle time that is perceived to be typical for the activity centers (110). The feedback (145) can account for visible queue lengths for all queues (120) in the process model (100) (including intermediate queues after the first stage), for only queue 1 for activity center 1 (as the initial input queue for tokens for the process model), or for any combination of the queues (120). Consider the example in which the process model (100) represents a fast food restaurant, with queue 1 representing the line at an order counter, queues 2 to I−1 representing lines at checkout counters, and queue I representing the line at a beverage counter. In this case, queues at all counters may be visible to a potential customer and affect the decision that the customer makes about going to the restaurant. Alternatively, if one of the queues is hidden, the feedback (145) can ignore queue length for that queue. The typical processing cycle time can be an average overall cycle time per token or other measure.

More generally, the feedback (145) relates to how potential new customers represented with tokens (121) perceive the performance of the process model (100), which affects decisions about their participation in the business process. The token generator (140) uses the feedback (145) to adjust token arrival. In particular, the impact of poor process performance on token arrival can be simulated, which can help an analyst to understand how many customers were lost due to poor process performance. In turn, an analyst can assess how increasing process capacity may reduce or eliminate loss of customers, or even increase customers as a result of better service. By illustrating tradeoffs between the costs of capacity increases and the benefits of more customers, the process analysis tool can help the analyst identify an appropriate capacity at which the overall cost of capacity increases and lost customers/opportunities is reduced. Adjusting token arrival based on process performance can support more meaningful business process analysis in many use case scenarios. For example:
In a grocery store, if there are long lines at checkout counters, some customers may leave the store or decide to go to another store. If more checkout counters are added, the queue lengths will be lower, but there is a cost to adding and maintaining more checkout counters. By using business process simulation in which token arrival is adjusted depending on process performance, an analyst can gain a better understanding of how and when long lines lead to loss of customers, and thus form better recommendations about addressing the situation.
Similarly, at a bank, fast food restaurant, gas station or other company offering a product or service, a potential customer may decide not to use the service or product if there are long lines visible to the customer. Additional ATMs, service counters, gas pumps, etc. will result in shorter lines but add costs. Business process simulation as described herein can help an analyst identify a better service capacity at which the overall cost of capacity increases and lost customers is reduced.
For an online transaction processing service or call center, a potential customer or caller may terminate the transaction or call if it is not handled in a reasonable time. Business process simulation as described herein can help with capacity planning for the transaction processing service or call center.
More generally, business process simulation as described herein can help with capacity planning at customer interface points for a company. By focusing on inputs (such as numbers of tokens awaiting processing) and overall outcomes (such as processing cycle times) of a process model, the state information used to adjust token arrival is largely independent of the details of the process model itself.

### I. Example Process Analysis Tools.

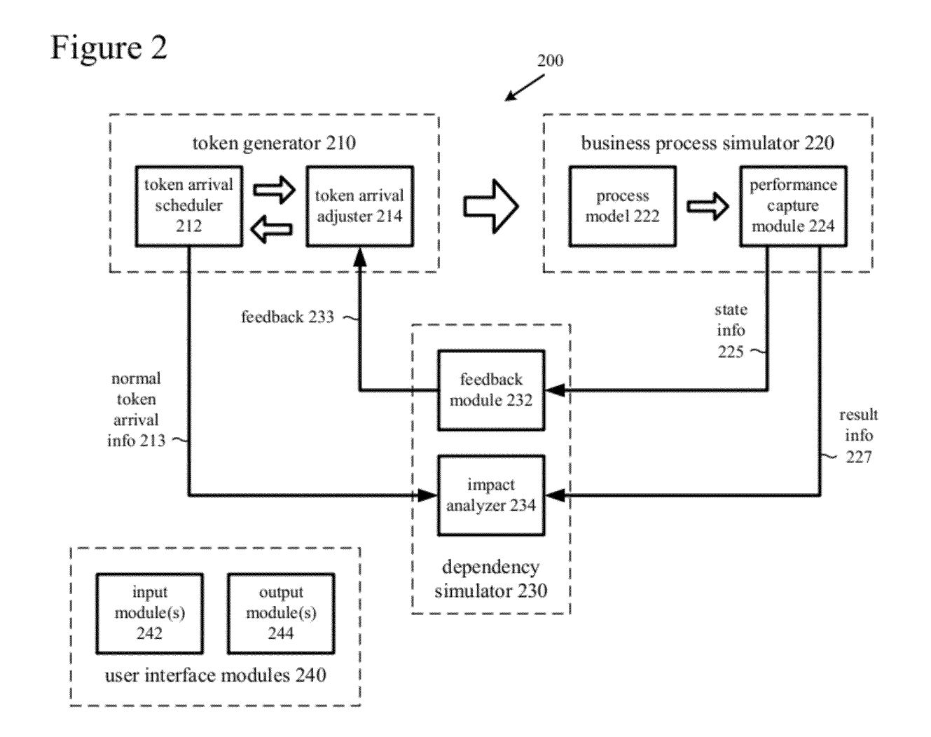

FIG. 2 shows an example process analysis tool (200) that includes a token generator (210), business process simulator (220), process-token arrival dependency simulator (230) and user interface modules (240). The process analysis tool (200) can be implemented in local or distributed computing system to provide business process simulation, business process management and/or other business process analysis functionality. The process analysis tool (200) simulates the dependency of token arrival on performance of a process model (222) in the business process simulator (220).

The token generator (210) includes a token arrival scheduler (212) and a token arrival adjuster (214). Through the token arrival scheduler (212) or otherwise, the token generator (210) is operable to schedule the arrival of tokens to the business process simulator (220). Through the token arrival adjuster (214) or otherwise, the token generator (210) is also operable to adjust one or more parameters that characterize the arrival of tokens. To adjust the parameter(s), the token generator (210) uses feedback that depends on the state of the process model (222). The token arrival scheduler (212) and token arrival adjuster (214) can exchange information regarding parameters used in token arrival scheduling. The token arrival scheduling uses a statistical model (typically, a probability distribution) that depends on implementation, and the parameters that characterize the token arrival scheduling depend on the type of statistical model. Table 2 illustrates examples of statistical models for token arrival scheduling in terms of a probability distribution used and parameter(s) that can be used for the distribution.

TABLE 2
Examples of statistical models for token arrival scheduling.

| probability distribution | parameter(s) |
|---|---|
| exponential | rate (or inter-token arrival time) |
| Poisson | rate (or inter-token arrival time) |
| normal (Gaussian) | mean, variance |
| uniform | minimum value, maximum value |
| triangular | minimum value, maximum value, mode |

In particular, the exponential distribution provides a useful way to model the arrival of new work/job orders represented by tokens. Alternatively, the token generator (210) uses a different statistical model (probability distribution) for token arrival scheduling or different parameters for one of the types of probability distributions shown in Table 2.

In any case, the token generator (210) adjusts one or more parameters that characterize the token arrival based upon feedback that depends on the state of the process model (222). For example, in some implementations, a rate parameter characterizes an exponential probability distribution for token arrival. The token generator (210) adjusts a current value R_{current} of the rate parameter according to feedback ƒ to determine an adjusted value R_{adjusted} for the rate parameter:

R_{adjusted}=R_{current}×ƒ.

Alternatively, the token generator (210) adjusts a current parameter using feedback according to another formula. Or, instead of a rate parameter, the parameter of the exponential distribution is an average inter-token arrival time parameter S_{current} that is adjusted according to feedback ƒ to determine an adjusted value S_{adjusted}, which indicates a modified average inter-token arrival time for the exponential distribution of tokens generated:

S_{adjusted}=S_{current}×ƒ.

The business process simulator (220) executes the process model (222). The business process simulator (220) includes a performance capture module (224) that is operable to measure the state of the process model. When the process model (222) includes activity centers, and each of the activity centers is associated with a queue of zero or more tokens, the state of the process model (222) includes a number of queued tokens waiting for the activity centers and a typical processing cycle time. The typical processing cycle time can be an average cycle time for the last N tokens that were processed, a median cycle time for the last N tokens that were processed, or another representative processing cycle time. The performance capture module (224) captures the number(s) of tokens waiting in queues at the activity centers, captures the typical processing cycle time for the last token(s) to be processed and/or captures other state information. Alternatively, the performance capture module (224) captures other state information for the process model (222). In this way, the performance capture module (224) measures the current state of the process model (222), especially with respect to features that are perceptible to a customer (such as visible queue lengths and perceived cycle time) and hence may affect customer decisions. The performance capture module (224) provides state information (225) indicating the measured state to the feedback module (232). The performance capture module (224) can also provide result information (227) (such as numbers of tokens processed) to an impact analyzer (234).

In the process-token arrival dependency simulator (230), the feedback module (232) calculates the impact of the state of the process model (222) on token arrival. The feedback module (232) is operable to generate feedback and provide the feedback to the token generator. The way that the feedback module (232) generates the feedback from the state information (225) depends on implementation. For example, suppose the process model (222) includes I activity centers, and each of the I activity centers is associated with a queue of zero or more tokens waiting for that activity center. The state of the process model (222) can include a number Qᵢ of tokens waiting per activity center i and an average processing cycle time T_{N} for a number N of tokens (e.g., the last N tokens processed). In this case, the feedback module can generate the feedback according to a feedback function ƒ that accounts for the impact of the queue lengths and the typical cycle time:

ƒ(Q₁, . . . , Qᵢ, T_{N})=1+K₁Q₁+ . . . +KᵢQᵢ+Kₜ(T_{N}−T_{target})

for activity center i from 1≦i≦I. In this equation, Kᵢ is a coefficient that relates the impact of queue length to the arrival of tokens, Kₜ is a coefficient that relates the impact of the average processing cycle time to the arrival of tokens, and T_{target} is a “target” processing cycle time at which the processing cycle time does not affect the normal token arrival rate.

The coefficients Kᵢ and Kₜ are set depending on implementation, and the feedback module (232) can be operable to set Kᵢ, Kₜ, N and/or another feedback function setting depending on input from the analyst, which facilitates adaptation of the feedback module (232) and process analysis tool (200) for different types of process models. For example, in one possible implementation, when the parameter that characterizes the token arrival is a rate parameter, the value of Kᵢ is set between 0.0 and −0.05, the value of Kₜ is set between 0.0 and −0.1, which results in decreases to the value of the rate parameter when queue length or cycle time increases. In another possible implementation, when the parameter that characterizes the token arrival is an average inter-token arrival time parameter, the value of Kᵢ is set between 0.0 and 0.05, the value of Kₜ is set between 0.0 and 0.1, and the value of T_{N} is normalized to 0 for a target cycle time, which results in increases to the value of the inter-token arrival time parameter when queue length or cycle time increases. Conversely, when queue lengths are zero and the cycle time T_{N} is less than the target cycle time, the parameter for token arrival can recover towards its original value (e.g., increasing the value of a rate parameter or decreasing the value of an inter-token arrival time parameter).

Alternatively, the process analysis tool (200) uses a different feedback function. For example, in addition to queue length and cycle time, the feedback function can include a “look-ahead” factor that the process analysis tool (200) uses for simulation of expected task completion for near-future tokens. In this way, the process analysis tool (200) can simulate the dependency of token arrival on perceived difficulty of processing for the next tokens that will be processed. (Work orders represented by tokens are not all equal—some tokens represent work orders that are significantly more complicated than other work orders. For example, for a process model that represents a grocery store, the “look-ahead” factor can assess how many items the customers ahead in line are purchasing, which affects expected processing time.)

In FIG. 2, the dependency simulator (230) also includes the impact analyzer (234) to aggregate the impact of feedback. The impact analyzer (234) receives information (213) regarding normal token arrival from the token arrival scheduler (212). Using this information and the result information (227) from the performance capture module (224), the impact analyzer (234) is operable to determine the aggregate effect of process performance on token arrival. The metric that the impact analyzer (234) uses depends on implementation. For example, the impact analyzer (234) determines a number N_{aggregate} of tokens lost or gained, in aggregate during a time interval, due to the performance of the process model:

N_{aggregate}=N₀−N_{feedback}.

In this equation, N₀ indicates a number of tokens processed during the time interval without the adjustment using the feedback, and N_{feedback} indicates a number of tokens processed during the time interval with the adjustment using the feedback. Alternatively, the impact analyzer (234) uses another metric to aggregate the effects of feedback on token arrival.

The user interface modules (240) include one or more input modules (242) and one or more output modules (244). A given input module (242) is operable to accept input specifying the process model, accept input specifying parameters for the arrival of tokens, accept input for user data and/or accept input for another purpose. A given output module (244) is operable to present visual indicators of effects of the feedback on the arrival of tokens, present visual indicators of the number of tokens processed, otherwise present results in a user-readable format and/or present some other form of output information. The process analysis tool (200) can also include one or more setting adjustment modules. A given setting adjustment module is operable to accept input specifying a setting of the process analysis tool (200) and to adjust the setting. The setting can be output format setting, feedback function setting, or other setting.

The functional modules shown in FIG. 2 are organized to facilitate explanation of how different features of the process analysis tool (200) work. Depending on implementation, the process analysis tool (200) may lack one or more of the modules shown in FIG. 2 and/or includes additional modules not shown in FIG. 2. For example, the process analysis tool (200) may lack input module(s) (242) or output module(s) (244).

Depending on implementation, functional modules shown in FIG. 2 can be combined, or a given module can be separated into multiple modules. For example, the feedback module (232) and performance capture module (224) can be combined, or the feedback module (232) and token arrival adjuster (214) can be combined, or the token arrival scheduler (212) and token arrival adjuster (214) can be combined. Moreover, at a high level, the modules shown in FIG. 2 can be organized differently than shown in FIG. 2. For example, the token generator (210) can include the feedback module (232) and/or performance capture module (224). In general, if a process analysis tool “includes” or “comprises” a given module shown in FIG. 2, no architectural or organizational limitation is implied for how that module relates to the tool or to other modules of the tool. Rather, the functionality of the given module can be separated from functionality of other modules or interspersed with functionality of other modules, depending on implementation.

### II. Example Techniques for Using Process Analysis Tools.

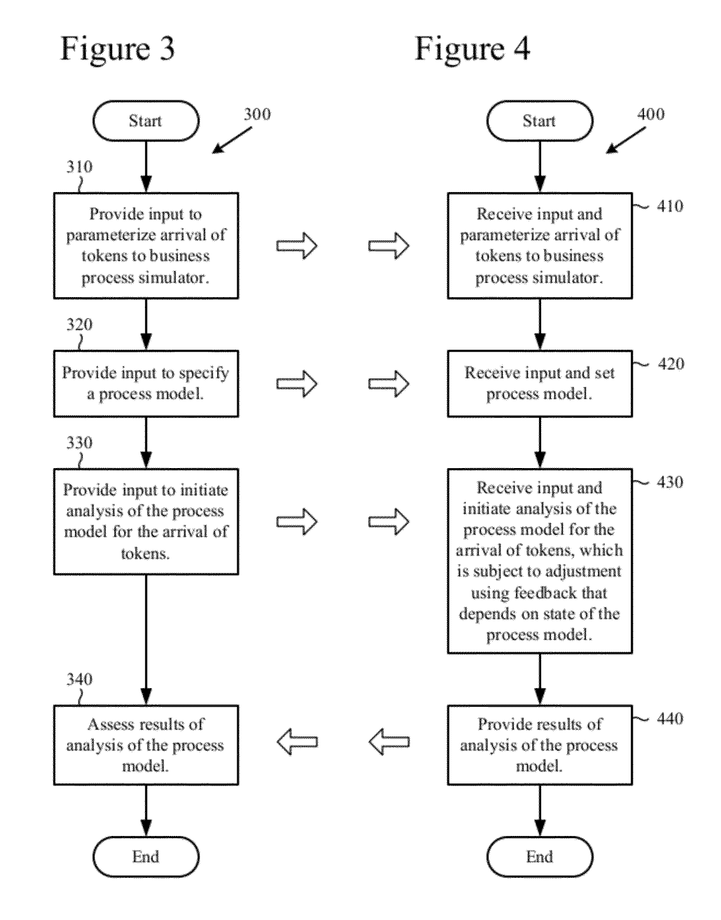

FIG. 3 shows a generalized technique (300) for a business analyst, other user or testing tool (generally, “analyst”) to use a process analysis tool that simulates dependency of token arrival on process performance. FIG. 4 shows a corresponding generalized technique (400) from the perspective of the computing system that implements the process analysis tool. The process analysis tool includes a token generator operable to schedule arrival of tokens to a business process simulator.

To start, the analyst provides (310) input to parameterize the arrival of tokens to the business process simulator and provides (320) input to specify a process model. The process analysis tool receives (410) the input to parameterize the arrival of tokens to the business process simulator, and parameterizes the arrival of tokens accordingly. The process analysis tool also receives (420) the input to specify the process model, and sets the process model accordingly. The analyst can also provide input to specify settings (e.g., an output format setting, feedback function settings) of the process analysis tool. In this case, the process analysis tool receives the input to specify settings and adjusts the settings accordingly.

The analyst provides (330) input to initiate analysis of the specified business process for the arrival of tokens as parameterized. The process analysis tool receives (430) the input and initiates analysis of the specified process model for the parameterized arrival of tokens. The arrival of tokens is subject to adjustment using feedback that depends on state of the specified process model, as explained above.

The process analysis tool provides (440) intermediate and/or final results of the analysis of the process model to the analyst. For example, the process analysis tool provides information regarding the effects of the feedback on the arrival of tokens and/or number of tokens processed. The analyst assesses (340) the results of the analysis. For example, the analyst can use the results of the analysis to modify the process model for the business process, then use the process analysis tool to evaluate the modified process model/business process.

### III. Example Techniques for Providing and Using Feedback to Adjust Token Arrival.

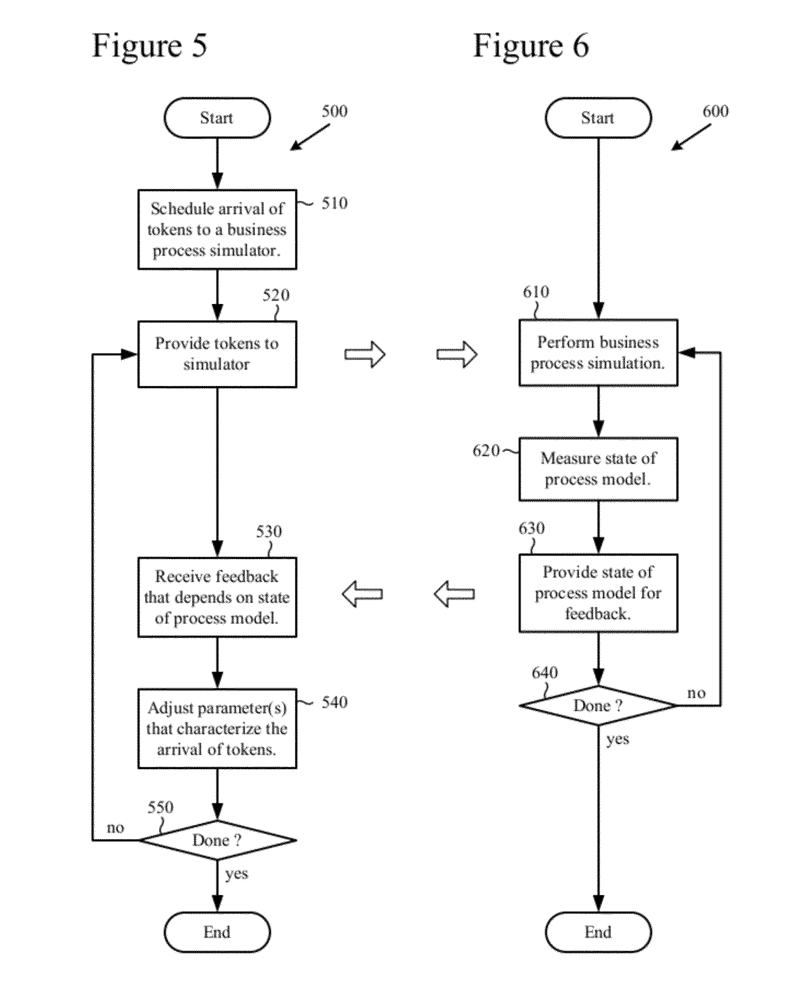

FIG. 5 shows a generalized technique (500) for adjusting token arrival based at least in part on feedback that depends on state of a process model. FIG. 6 shows a corresponding generalized technique (600) for measuring and providing state of a process model for feedback to token arrival scheduling. A computing system that implements a process analysis tool, such as the process analysis tool (200) shown in FIG. 2, or other process analysis tool can perform the technique (500) and/or the technique (600). For example, the technique (500) is performed as part of processing for a token generator, and the technique (600) is performed as part of processing for a business process simulator. Different process analysis tools can perform the techniques (500, 600).

A process analysis tool schedules (510) arrival of tokens to a business process simulator. One or more parameters characterize the arrival of tokens. For example, the parameter(s) include a rate for an exponential distribution for token generation. Alternatively, the parameter(s) include other and/or additional parameters. The process analysis tool provides (520) tokens to the business process simulator.

A process analysis tool performs (610) business process simulation of the process model and measures (620) the state of the process model. For example, the state of the process model can include a number of tokens waiting for one or more activity centers, a representative processing cycle time and/or other state information. The process analysis tool provides (630) the measured state of the process model for feedback, which is generated from the measured state of the process model. For example, the process analysis tool generates the feedback using a feedback function as described in Section I. The feedback can relate to processing cycle time for one or more activity centers of the process model, queue length for waiting tokens in one or more queues of the process model, and/or other indicia of process performance that a customer may perceive.

A process analysis tool receives (530) the feedback that depends on the state of the process model. Based at least in part on the feedback, the process analysis tool adjusts (540) at least one of the parameter(s) that characterize the arrival of tokens, so as to simulate dependency on performance of the process model. For example, the adjustment can simulate the effects of perception of processing cycle time for the one or more activity centers on the arrival of tokens, or the adjustment can simulate the effects of perception of queue length on the arrival of tokens, or the adjustment can simulate both. Alternatively, the adjustment simulates other effects of the perception of process performance on token arrival.

The process analysis tool(s) check (550, 640) whether processing is done. If not, the process analysis tool(s) continue by providing (520) tokens to the business process simulator (according to the adjusted token arrival scheduling) and performing (610) the business process simulation for the process model.

Although not shown in FIGS. 5 and 6, a process analysis tool can perform other operations, such as determining an aggregate number of tokens lost during a time interval due to the performance of the process model, or presenting visual indicators of effects of the feedback on the arrival of tokens and/or number of tokens processed.

### IV. Example Computing Systems.

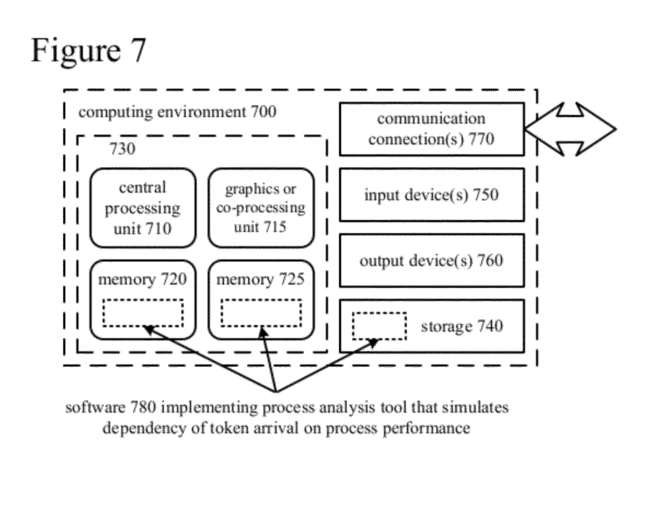

FIG. 7 illustrates a generalized example of a suitable computing system (700) in which described techniques and tools may be implemented. The computing system (700) is not intended to suggest any limitation as to scope of use or functionality of the techniques and tools, which may be implemented in diverse general-purpose or special-purpose computing environments. For example, the described techniques and tools may be implemented using a local computing system (e.g., a server computer, desktop computer, laptop computer, netbook, tablet device, hand-held device, mobile device, PDA, etc.). Or, the techniques and tools described herein can be performed in a cloud computing environment (e.g., comprising virtual machines and underlying infrastructure resources), mainframe computer, a collection of client/server systems, and the like. Generally, the disclosed techniques and tools may be implemented in distributed computing systems where tasks are performed by remote devices that are linked through a communications network, and program modules may be located in local and/or remote memory or storage.

With reference to FIG. 7, the computing system (700) includes at least one processor (such as a central processing unit (710)) and memory (720). In FIG. 7, this most basic configuration (730) is included within a dashed line. The processor (710) executes computer-executable instructions. In a multi-processing system, multiple processors (e.g., including the processing unit (715) having associated memory (725)) execute computer-executable instructions to increase processing power and as such, multiple processors can be running simultaneously. The memory (720, 725) may be volatile memory (e.g., registers, cache, RAM), non-volatile memory (e.g., ROM, EEPROM, flash memory, etc.), or some combination of the two. The memory (720, 725) stores software (780) implementing the techniques and tools described herein.

A computing system may have additional features. For example, the computing system (700) includes storage (740), one or more input devices (750), one or more output devices (760), and one or more communication connections (770). An interconnection mechanism (not shown) such as a bus, a controller, or a network, interconnects the components of the computing system (700). Typically, operating system software (not shown) provides an operating environment for other software executing in the computing system (700), and coordinates activities of the components of the computing system (700).

The storage (740) may be removable or non-removable, and may include magnetic disks, magnetic tapes or cassettes, CD-ROMs, CD-RWs, DVDs, or any other tangible storage medium which can be used to store information and which can be accessed within the computing system (700). The storage (740) stores instructions for the software (780), which can implement techniques and tools described herein.

The input device(s) (750) may be a touch input device, such as a keyboard, keypad, mouse, pen, or trackball, a voice input device, a scanning device, or another device, that provides input to the computing system (700). The output device(s) (760) may be a display, printer, speaker, CD-writer, or another device that provides output from the computing system (700).

The communication connection(s) (770) enable communication over a communication medium (e.g., a connecting network) to another computing entity. The communication medium conveys information such as computer-executable instructions, compressed graphics information, or other data in a modulated data signal.

The techniques and tools can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. The computer-executable instructions can be part of, for example, a dedicated software application or a software application that is remotely accessed or downloaded via a web browser or other software application (such as a remote computing application) via any suitable communication means. Such software can be executed, for example, on a single local computer or in a distributed computing system (e.g., via the Internet, a wide-area network, a local-area network, a client-server network, or other network) using one or more network computers.

Any of the disclosed techniques and tools can be implemented using computer-executable instructions stored on one or more computer-readable media (tangible computer-readable storage media, volatile memory components, and/or non-volatile memory components) and executed on a computing system. By way of example, computer-readable media include memory (720) and/or storage (740). Any of the computer-executable instructions for implementing the disclosed techniques and tools, as well as any data created and used during implementation of the disclosed techniques and tools, can be stored on one or more computer-readable media.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

### V. Alternatives and Variations.

Various alternatives to the examples described herein are possible. The various aspects of the innovations described herein can be used in combination or separately. Different embodiments may use one or more of the described techniques and tools.

Although the operations of some of the disclosed techniques are described in a particular, sequential order for convenient presentation, it should be understood that this manner of description encompasses rearrangement, unless a particular ordering is required. For example, operations described sequentially may in some cases be rearranged or performed concurrently. Techniques described with reference to flowchart diagrams can be altered by changing the ordering of stages shown in the flowcharts, by splitting, repeating or omitting certain stages, etc. Moreover, for the sake of simplicity, the attached figures may not show the various ways in which the disclosed techniques can be used in conjunction with other techniques.

For clarity and brevity, only certain selected aspects of the software-based implementations are described. Other details that are well known in the art are omitted. For example, it should be understood that the disclosed technology is not limited to any specific computer language or program. Likewise, the disclosed technology is not limited to any particular computer or type of hardware. Certain details of suitable computers and hardware are well known and need not be set forth in detail in this disclosure. The disclosed technology is not limited to any particular business process modeling language or standard, nor is it limited to any particular way of parameterizing token arrival.

The disclosed techniques and tools should not be construed as limiting in any way. Instead, the present disclosure is directed toward all novel and nonobvious features and aspects of the various disclosed embodiments, alone and in various combinations and sub-combinations with one another. The disclosed techniques and tools are not limited to any specific aspect or feature or combination thereof, nor do the disclosed embodiments require that any one or more specific advantages be present or problems be solved. In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A computing system that implements a process analysis tool, wherein the computing system includes a processor and memory, the process analysis tool comprising:
a token generator operable to schedule arrival of tokens to a business process simulator and, using feedback that depends on state of a process model, adjust a parameter that characterizes the arrival of tokens; and
a feedback module operable to generate the feedback for the token generator to simulate dependency of the arrival of tokens on performance of the process model.

2. The computing system of claim 1 wherein the process analysis tool further comprises:
the business process simulator, wherein the business process simulator executes the process model and includes a performance capture module operable to measure the state of the process model.

3. The computing system of claim 1 wherein the token generator includes a token arrival scheduler operable to perform the scheduling of the arrival of tokens and a token arrival adjuster operable to perform the adjustment of the parameter that characterizes the arrival of tokens.

4. The computing system of claim 1 wherein the process model includes activity centers, each of the activity centers being associated with a queue of zero or more tokens, and wherein the state of the process model includes a number of queued tokens waiting for the activity centers and a typical processing cycle time.

5. The computing system of claim 1 wherein the process model includes I activity centers, each of the I activity centers being associated with a queue of zero or more tokens waiting for that activity center, wherein the state of the process model includes a number Qᵢ of tokens waiting per activity center at activity center i and an average processing cycle time T_{N} for a number N of tokens last processed, and wherein the feedback module is operable to generate the feedback according to a feedback function ƒ:
ƒ(Q₁, . . . , Qᵢ, T_{N})=1+K₁Q₁+ . . . +KᵢQᵢ+Kₜ(T_{N}−T_{target}),
for 1≦i≦I, where Kᵢ is a coefficient that relates impact of queue length to the arrival of tokens, where Kₜ is a coefficient that relates impact of the average processing cycle time to the arrival of tokens, and T_{target} is a target processing cycle time.

6. The computing system of claim 5 wherein the feedback module is operable to set Kᵢ, Kₜ, and N, thereby facilitating adaptation of the feedback module for different types of process model.

7. The computing system of claim 1 wherein the parameter that characterizes the arrival of tokens is a rate parameter R_{current} for a probability distribution, and wherein the token generator is operable to adjust the rate parameter R_{current} according to:
R_{adjusted}=R_{current}×ƒ,
where ƒ quantifies the feedback and R_{adjusted} is an adjusted rate parameter for the probability distribution.

8. The computing system of claim 1 wherein the process analysis tool further comprises:
an impact analyzer operable to determine a number N_{aggregate} of tokens lost, in aggregate during a time interval, due to the performance of the process model according to:
N_{aggregate}=N₀−N_{feedback},
where N₀ indicates a number of tokens processed during the time interval without the adjustment using the feedback, and where N_{feedback} indicates a number of tokens processed during the time interval with the adjustment using the feedback.

9. The computing system of claim 1 wherein the process analysis tool further comprises one or more of:
a setting adjustment module operable to accept input regarding settings of the process analysis tool and adjust the settings of the process analysis tool, wherein the settings include an output format setting and/or feedback function settings of the feedback module;
an input module operable to accept input regarding the process model and/or the arrival of tokens; and
an output module operable to present visual indicators of effects of the feedback on the arrival of tokens and/or number of tokens processed.

10. In a computing system that implements a process analysis tool, the computing system including a processor and memory, a method comprising:
scheduling arrival of tokens to a business process simulator, wherein one or more parameters characterize the arrival of tokens;
receiving feedback that depends on state of a process model in the business process simulator; and
with the computing system that implements the process analysis tool, based at least in part on the feedback, adjusting at least one of the one or more parameters that characterize the arrival of tokens to simulate dependency on performance of the process model.

11. The method of claim 10 wherein the one or more parameters that characterize the arrival of tokens include a rate for a probability distribution, and wherein the probability distribution is an exponential distribution.

12. The method of claim 10 further comprising:
measuring the state of the process model, wherein the state of the process model includes a number of tokens waiting for one or more activity centers and a representative processing cycle time; and
generating the feedback from the measured state of the process model.

13. The method of claim 10 wherein the process model includes one or more activity centers, and wherein the adjustment simulates effects of perception of processing cycle time for the one or more activity centers on the arrival of tokens.

14. The method of claim 13 wherein each of the one or more activity centers is associated with a queue of zero or more tokens waiting for that activity center, and wherein the adjustment further simulates effects of perception of queue length on the arrival of tokens.

15. The method of claim 10 wherein the process model includes one or more queues, and wherein the adjustment simulates effects of perception of queue length on the arrival of tokens.

16. The method of claim 10 further comprising:
accepting input regarding settings of the process analysis tool, wherein the settings include an output format setting and/or feedback function settings; and
adjusting one or more of the settings of the process analysis tool according to the input.

17. The method of claim 10 further comprising:
determining an aggregate number of tokens lost during a time interval due to the performance of the process model.

18. The method of claim 10 further comprising:
presenting visual indicators of effects of the feedback on the arrival of tokens and/or number of tokens processed.

19. A method of using a computing system that implements a process analysis tool, wherein the computing system includes a processor and memory, and wherein the process analysis tool includes a token generator operable to schedule arrival of tokens to a business process simulator, the method comprising:
receiving first input to parameterize the arrival of tokens to the business process simulator;
receiving second input to specify a process model; and
with the computing system that implements the process analysis tool, initiating analysis of the specified process model for the parameterized arrival of tokens, the parameterized arrival of tokens being subject to adjustment using feedback that depends on state of the specified process model.

20. The method of claim 19 further comprising:
receiving third input to specify settings of the process analysis tool, wherein the settings include feedback function settings.
